(19) United States
(12) Patent Application Publication
(10) Pub. No.: US 2018/0374142 A1
(43) Pub. Date: Dec. 27, 2018

(54) SYSTEM AND METHOD FOR SHARING PERSONALIZED ELECTRONIC COMMERCE REQUESTS

(71) Applicant: Ask to Pay Ltd., Ramat Gan (IL)

(72) Inventor: Avihai MICHAELI, Ramat Gan (IL)

(73) Assignee: Ask to Pay Ltd., Ramat Gan (IL)

(21) Appl. No.: 16/017,240

(22) Filed: Jun. 25, 2018

Related U.S. Application Data
(60) Provisional application No. 62/524,629, filed on Jun. 26, 2017.

(51) Int. Cl. G06Q 30/06

(52) U.S. Cl. CPC G06Q 30/0637

(57) ABSTRACT

A system and method for sharing a personalized purchase request for an item offered via a web page of an electronic commerce (e-commerce) website are provided. The method includes detecting a purchase request by a user of a first user device; identifying a plurality of key purchase parameters, wherein the key purchase parameters include a limited set of information included in the web page; generating a personalized purchase request based on the plurality of key purchase parameters and at least one identifier related to the first user device; and sharing the personalized purchase request with at least a second user device by at least one of: sending a link to the personalized purchase request, and sending a widget including code that, when executed at the second user device, configures the second user device to display the personalized purchase request.

### CROSS-REFERENCE TO RELATED APPLICATIONS

This application claims the benefit of U.S. Provisional Application No. 62/524,629 filed on Jun. 26, 2017, the contents of which are hereby incorporated by reference.

### TECHNICAL FIELD

The present disclosure relates generally to electronic commerce, and more particularly to methods and systems for sharing personalized requests for electronic commerce purchases.

### BACKGROUND

The way people shop has significantly progressed since the development of the worldwide web (WWW). Consumers can now shop from the convenience of their home, office, or while on the road using portable devices.

Popular websites such as Amazon.com® and Shopping.com® allow consumers to purchase goods directly through their websites, often for reduced prices as compared to local merchants and without requiring physically entering a store or mailing an order form. From a merchant's point of view, it allows access to a worldwide market of consumers.

Payment via electronic commerce websites is made by electronic payment methods, such as, for example, by entering credit card information, using third party payment platforms (e.g., Paypal®), and the like. As an example, in case a minor wants to make a purchase online while away from their parent and lacks payment methods such as a credit card, the minor typically asks the parent to provide the parent's credit card details via phone or electronic message.

Naturally, due to the liquidity of information in today's world and the obvious fear of theft, a purchaser (e.g., the parent) may not feel comfortable providing such information. On the other hand, the purchaser may not want to disappoint the requester (e.g., the minor) by denying the purchase.

Alternatively, the requester may send the purchaser a link to the item they desire, for example via email or text message. However, the link does not provide information about the requested purchase. Accordingly, the requester must either provide purchase details, or the purchaser must investigate the entire web page pointed to by the link. Further, the purchaser may be required to log in to the electronic commerce website in order to complete the purchase, which may be convenient if, for example, the purchaser does not store their login information for the electronic commerce website on the device used to receive the request. This results in slower and/or less accurate evaluations of purchases by users, which in turn may result in loss of sales or returned items due to confusion and/or frustration during the purchase.

Additionally, due to the ability of hackers to emulate requesters (e.g., by sending messages from phone numbers or email addresses that resemble those of the requesters), purchasers may reject the purchase for fear of fraudulent requests.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for sharing a personalized purchase request for an item offered via a web page of an electronic commerce (e-commerce) website, comprising: detecting a purchase request by a user of a first user device; identifying a plurality of key purchase parameters, wherein the key purchase parameters include a limited set of information included in the web page; generating a personalized purchase request based on the plurality of key purchase parameters and at least one identifier related to the first user device; and sharing the personalized purchase request with at least a second user device by at least one of: sending a link to the personalized purchase request, and sending a widget including code that, when executed at the second user device, configures the second user device to display the personalized purchase request.

Certain embodiments disclosed herein also include a system for sharing a personalized purchase request for an item offered via a web page of an electronic commerce (e-commerce) website. The system comprising: a processing circuitry; and a memory, the memory containing instructions that, when executed by the processing circuitry, configure the system to: detect purchase request by a user of a first user device; identify a plurality of key purchase parameters, wherein the key purchase parameters include a limited set of information included in the web page; generate a personalized purchase request based on the plurality of key purchase parameters and at least one identifier related to the first user device; and share the personalized purchase request with at least a second user device by at least one of: sending a link to the personalized purchase request, and sending a widget including code that, when executed at the second user device, configures the second user device to display the personalized purchase request.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system for sharing personalized electronic commerce payments according to an embodiment.

FIG. 2 is a flowchart illustrating a method for sharing personalized electronic commerce payments according to an embodiment.

FIG. 3 is a flowchart illustrating a method for completing an electronic commerce purchase based on a personalized electronic commerce request according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for sharing personalized electronic commerce (e-commerce) requests. An operator of an e-commerce website registers the e-commerce website for a service providing customized purchase requests. One or more interactive elements are implemented in the e-commerce website. The interactive elements are configured such that, when a user of a first requester device interacts with an interactive element, a deliverable widget or a link is generated and sent to a second purchaser device. The widget is at least a portion of code that when executed at a user device, configures the user device to display at least a portion of a graphical user interface (GUI) including key purchase parameters related to the purchase request and identifiers of the requester. The link may be to a web page through which the requested item may be purchased. Such key purchase parameters include, but are not limited to, information of the requested item (e.g., name, price, color/style, etc.) and merchant information. The identifiers of the requester include requester information such as, but not limited to, name, multimedia content showing the requester, contact information, and the like. The portion of code may include a template allowing for providing custom requester information. The template may be edited prior to inclusion in the widget to allow for customization of the requester information.

The multimedia content may be provided and customized by a user of the requester device. To this end, the link on the e-commerce website may point to a location of a template editor configured to allow for uploading and customization of at least the requester information by the user of the requester device. Specifically, textual information can be added, multimedia content can be uploaded, the multimedia content can be edited, and the like. The multimedia content may include, but is not limited to, video, audio, graphics interchange format files (GIFs), combinations thereof, and the like. The customized requester information is added to a template including the other information related to the purchase request.

When the interactive elements are implemented via the e-commerce website, a purchase request for purchasing an item via an electronic commerce (e-commerce) platform is received from a first requester device. The purchase request may be received when a user of the first requester device interacts with an interactive element of a respective item sold via the e-commerce website (e.g., a link on a web page for the item). Alternatively, the interaction may by via an application program e.g., an app. The purchase request includes an identifier of an item to be purchased. To this end, the purchase request may indicate contents of an electronic shopping cart including the item. One or more identifiers are received from the requester device. The purchase request also includes an identifier related to the requester device. Such an identifier may be, but is not limited to, a device ID of the requester device, a name of the requester, a user name associated with the requester, and the like.

Upon user interaction with the interactive element in the e-commerce website, a customized payment request is generated based on the requested item, the e-commerce website, and the identifiers. The customized payment request includes a template containing the key purchase parameters from the e-commerce website. The key purchase parameters included in the template include a reduced set of information related to the item (e.g., item and merchant information) to allow for more efficient and accurate user understanding of the purchase request as compared to the entire set of information included in a web page of the e-commerce website that offers the item for sale.

In some implementations, the customized payment request further includes multimedia content provided by the requester such as, for example, a video showing the requester asking for the item. The multimedia content provides additional security against fraudulent requests. The multimedia content may be customized by the user of the requester device as described above.

A link to the customized payment request is sent to a second purchaser device. When activated, the link causes display of the customized payment request and allows a user of the purchaser device to complete the purchase by confirming the transaction, providing payment information, both, and the like.

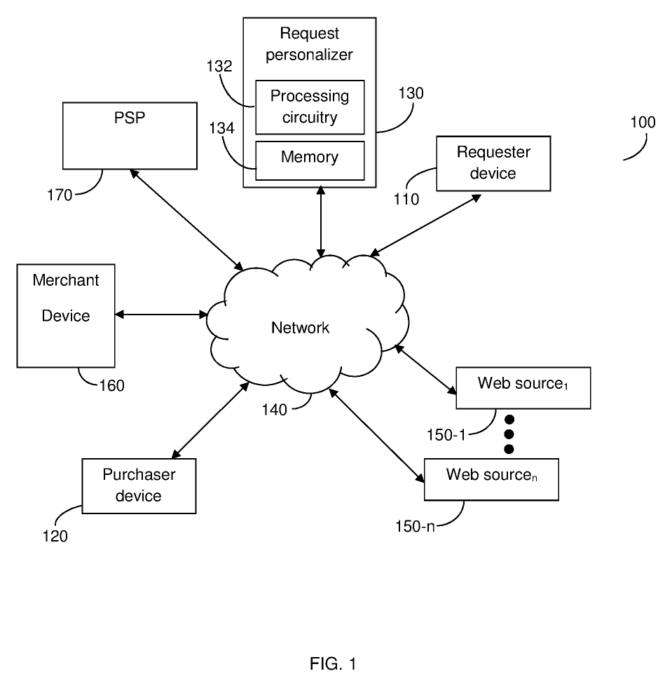

FIG. 1 shows an example schematic diagram of a system 100 for sharing personalized electronic commerce payments according to an embodiment. A requester device 110, a first purchaser device 120, a second request device 130, web sources 150-1 through 150-n (hereinafter referred to individually as a web source 150), a merchant device 160, and a payment service provider (PSP) system 170 communicate over a network 140. The network 140 may be, but is not limited to, a wireless, cellular or wired network, a local area network (LAN), a wide area network (WAN), a metro area network (MAN), the Internet, the worldwide web (WWW), similar networks, and any combination thereof.

Each of the requester device 110, the purchaser device 120, and the merchant device 160 is a user device such as, but not limited to, a personal computer (PC), a personal digital assistant (PDA), a mobile phone, a smart phone, a tablet computer, a wearable computing device and other kinds of wired and mobile appliances, equipped with image capturing, browsing, viewing, listening, filtering, managing, and other capabilities that are enabled as further discussed herein below. Each user device may have installed thereon an application (not shown) such as, but not limited to, a web browser, or an application associated with the web source 150 (e.g., a shopping application).

The request personalizer 130 is configured to provide personalized purchase requests as described herein. To this end, the request personalizer 130 includes a processing circuitry 132 and a memory 134.

The processing circuitry 132 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 134 contains instructions which, when executed by the processing circuitry 132, configures the request personalizer to perform one or more of the embodiments described herein.

The web source 150 is associated with a merchant of the merchant device 160. The web source 150 is an e-commerce website through which a user may purchase goods and services. The web source 150 may be accessible through a browser, through a dedicated application (i.e., the application installed on the requester device 110 or purchaser device 120), or both. The merchant device 160 is utilized to register the web source 150 for personalized purchase requests provided by the request personalizer 130.

In an embodiment, when the merchant device 160 is utilized to register the web source 150 for personalized purchase requests, the request personalizer 130 is configured to add at least one interactive element to the web source 150. The interactive element may be a visual element to be displayed by a web browser or application. For example, a button may be added to each web page hosted by the web source 150 representing a distinct item. The button, when interacted with, may send a purchase request to the request personalizer 130, may cause display of a template editor via a user interface of the requester device 110 to allow for customizing requester information, and the like. The template editor may be, for example, included in a web page associated with the request personalizer 130.

In an embodiment, the request personalizer 130 is configured to detect a request for an item (i.e., a good or service) by a user of the requester device 110 and to generate a personalized purchase request based on the detected request. The request may be detected explicitly (e.g., by interacting with a link implemented in the web source 150) or implicitly. The request personalizer 130 may be configured to track activity of a user of the requester device 110 and to implicitly detect a request for an item based on the tracked activity. The activity may include, but is not limited to, the amount of time the user spent searching for a certain item (i.e., a good or service), one or more gestures received from the user of the consumer device 110, queries or portions thereof, stacking of a shopping cart/basket and the like.

The generated personalized purchase request includes a set of key request parameters related to the request and one or more identifiers of the requester. In an embodiment, such key parameters include one or more identifiers of the requested item and merchant information of the seller of the item. The personalized purchase request may further allow for providing payment information via the payment service provider (PSP) system 170 when sent to the purchaser device 120 either directly or via a link (e.g., a link to a web page of the PSP 170) embedded therein. The PSP system 170 may be, for example, a server of a payment services provider such as, but not limited to, a bank, a credit card company, a third party payment provider (e.g., PayPal®), and the like.

The requester information includes an identifier related to the requester such as, but not limited to, a phone number of the requester device 110, an identification number associated with the requester, text containing a password, and the like. The requester information may further include multimedia content demonstrating the user of the requester device 110. For example, the multimedia content may be a video showing the requester asking for the item.

In an example implementation, the multimedia content element demonstrating the requester may be, but is not limited to, video, audio, a graphics interchange format (GIF) file, a combination thereof, and the like. The multimedia content may be provided, customized, or both, by the requester via the requester device 110. Specifically, the interactive element in the web source 150 may include a link such that, upon interaction with the interactive element, the requester device 110 is directed to a template editor allowing for uploading of the multimedia content, customization of the multimedia content, or both. The customization may be performed using one or more filters included in the personalized payment request. Such filters may allow customization such as, but not limited to, adding other content as an overlay, adding textual content, and the like.

In an embodiment, the request personalizer 130 is configured to share the generated personalized purchase request with the purchaser device 120. To this end, the request personalizer 130 may be configured to generate a deliverable widget or a link, and to send the widget or link at least to the purchaser device 120. The widget is a portion of code that, when executed at the purchaser device 120, configures the purchaser device 120 to display the personalized purchase request. The link is to a location of the personalized purchase request.

When the purchase is completed, the request personalizer 130 is configured to receive a confirmation of completion of the purchase from the purchaser device 120, the PSP 170, or the merchant device 160. The request personalizer 130 may be configured to send a notification indicating the completion of the purchase to the requester device 110.

It should be understood that the embodiments described herein are not limited to the specific architecture illustrated in FIG. 1, and other architectures may be equally used without departing from the scope of the disclosed embodiments.

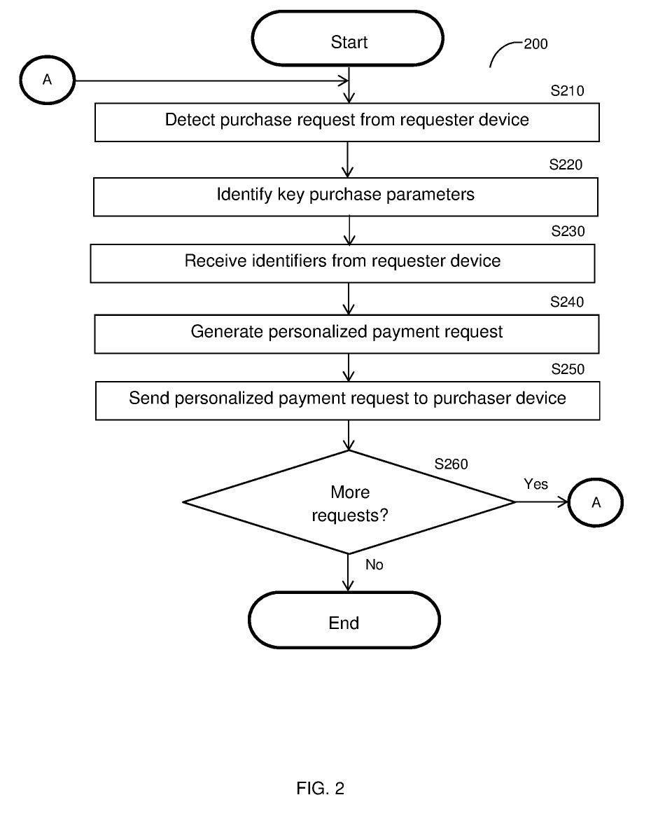

FIG. 2 is an example flowchart 200 illustrating a method for sharing personalized purchase requests according to an embodiment. In an embodiment, the method may be performed by the request personalizer 130, FIG. 1.

At S210, a purchase request for purchasing an item via an e-commerce website is detected. The request may be detected explicitly, i.e., the request may be received from a first requester device (e.g., the requester device 110, FIG. 1). For example, the request may be received when a user of the requester device interacts with an interactive element in a web page associated with personalizing purchase requests.

At S220, key request parameters related to the item are identified. The key request parameters include information related to the requested item and a merchant selling the item. The key request parameters may include, but are not limited to, an identifier of the item, a link to a web page offering the item, visual content showing the item, an indication of the e-commerce website offering the item, and the like.

The key request parameters represent a limited set of information as compared to the entire description of the item on a web page of the e-commerce platform. To this end, the key request parameters may include predetermined types of information such as, for example, listing name, price, condition, and the like. The key request parameters may be identified based on key words identified in the web page, relative locations of information in the web page (i.e., relative locations of display in which the information is displayed on a browser or other application), and the like. For example, the key words “near mint” may be identified as a condition, and information included in a top section of the item listing may be identified as the name of the item. Accordingly, the key purchase parameters allow for more accurate and efficient determination of whether the purchase should be completed by the purchaser.

At S230, one or more identifiers of the requester are received, for example from the requester device. The identifiers received at S230 may include, but are not limited to, a name, a user name, an address, contact information, multimedia content demonstrating the requester, and the like. Alternatively, the identifiers of the requester may be included in the purchase request, for example, when the interactive element prompts redirection to a web page including a template editor allowing for customization of the requester information.

In an embodiment, S230 includes receiving multimedia content demonstrating the requester. The multimedia content may be, for example, audio, video, a GIF, and the like. As a non-limiting example, the multimedia content may be video of the requester asking for the item. The multimedia content acts as an additional verification that the request is legitimate. The multimedia content may be provided by the requester device, for example, by uploading the multimedia content. In a further embodiment, the multimedia content may be customized. To this end, S230 may include receiving, through the template editor, selections of modifications to the multimedia content.

At S240, a personalized purchase request is generated based on the key purchase parameters. The personalized purchase request includes the key purchase parameters.

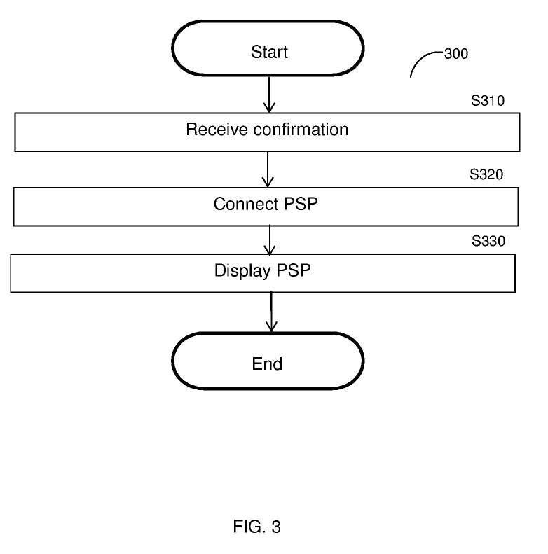

At optional S250, the personalized purchase request may be shared with a purchaser device (e.g., the purchaser device 120, FIG. 1). The sharing may include, but is not limited to, sending a widget including code for configuring the purchaser device to display the personalized purchase request, sending a link to a location of the personalized purchase request, or both. The personalized purchase request, when displayed on the requester device, may allow the purchaser to complete the purchase by, for example, entering payment information, redirecting the purchaser to a payment service provider system for entry of payment information, and the like. Completing purchases via personalized purchase requests is described further with respect to FIG. 3.

At S260, it is determined if additional purchase requests have been detected and, if so, execution continues with S210; otherwise, execution terminates.

As a non-limiting example, a child wishes to buy a shirt via the eBay® website. The child clicks on a button interactive element in a web page of the shirt. Key purchase parameters related to the item including a price and name of the listing are identified in the web page. The child is directed to a template editor asking the child to record a video asking for the shirt and to provide his or her name. A personalized purchase request is generated based on the key purchase parameters. The personalized purchase request includes the recorded video. A link to the personalized purchase request is sent to a device of the child's parent.

FIG. 3 is an example flowchart 300 illustrating a method for completing a purchase via a personalized purchase request according to an embodiment. At S310, a confirmation of the purchase is received from the purchaser device. At S320, the purchaser device is connected to a system of a payment services provider (PSP). At S330, an interface for the PSP is caused to be displayed on the purchaser device.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for sharing a personalized purchase request for an item offered via a web page of an electronic commerce (e-commerce) website, comprising:
detecting a purchase request by a user of a first user device;
identifying a plurality of key purchase parameters, wherein the key purchase parameters include a limited set of information included in the web page;
generating a personalized purchase request based on the plurality of key purchase parameters and at least one identifier related to the first user device; and
sharing the personalized purchase request with at least a second user device by at least one of: sending a link to the personalized purchase request, and sending a widget including code that, when executed at the second user device, configures the second user device to display the personalized purchase request.

2. The method of claim 1, wherein the purchase request is detected explicitly when the user of the first user device interacts with an interactive element included in the web page.

3. The method of claim 1, further comprising:
tracking activity by the user of the first user device on the e-commerce website, wherein the purchase request is detected implicitly based on the tracked activity.

4. The method of claim 1, wherein the key request parameters are identified based on at least one of: relative locations of display of information included in the web page, and at least one key word included in the web page.

5. The method of claim 1, wherein the at least one identifier related to the first user device includes multimedia content demonstrating the user of the first user device.

6. The method of claim 5, further comprising:
receiving, from the first user device, the multimedia content and at least one selection of modifiers to the multimedia content; and
customizing the multimedia content based on the at least one selection, wherein the personalized purchase request further includes the customized multimedia content.

7. The method of claim 5, wherein the multimedia content element is a video showing the user of the first user device asking for the item.

8. The method of claim 1, wherein the sharing includes sending the widget, wherein the widget further includes code that, when executed at the second user device, configures the second user device to prompt a user of the second user device for payment information.

9. The method of claim 1, further comprising:
connecting the second user device to a payment services provider system when a confirmation of the personalized purchase request is received from the second user device; and
causing a display of an interface for the payment services provider.

10. A non-transitory computer readable medium having stored thereon instructions for causing a processing circuitry to execute a process for sharing a personalized purchase request for an item offered via a web page of an electronic commerce (e-commerce) website, the process comprising:
detecting a purchase request by a user of a first user device;
identifying a plurality of key purchase parameters, wherein the key purchase parameters include a limited set of information included in the web page;
generating a personalized purchase request based on the plurality of key purchase parameters and at least one identifier related to the first user device; and
sharing the personalized purchase request with at least a second user device by at least one of: sending a link to the personalized purchase request, and sending a widget including code that, when executed at the second user device, configures the second user device to display the personalized purchase request.

11. A system for sharing a personalized purchase request for an item offered via a web page of an electronic commerce (e-commerce) website, comprising:
a processing circuitry; and
a memory, the memory containing instructions that, when executed by the processing circuitry, configure the system to:
detect purchase request by a user of a first user device;
identify a plurality of key purchase parameters, wherein the key purchase parameters include a limited set of information included in the web page;
generate a personalized purchase request based on the plurality of key purchase parameters and at least one identifier related to the first user device; and
share the personalized purchase request with at least a second user device by at least one of: sending a link to the personalized purchase request, and sending a widget including code that, when executed at the second user device, configures the second user device to display the personalized purchase request.

12. The system of claim 11, wherein the purchase request is detected explicitly when the user of the first user device interacts with an interactive element included in the web page.

13. The system of claim 11, wherein the system is further configured to:
track activity by the user of the first user device on the e-commerce website, wherein the purchase request is detected implicitly based on the tracked activity.

14. The system of claim 11, wherein the key request parameters are identified based on at least one of: relative locations of display of information included in the web page, and at least one key word included in the web page.

15. The system of claim 11, wherein the at least one identifier related to the first user device includes multimedia content demonstrating the user of the first user device.

16. The system of claim 15, wherein the system is further configured to:
receive, from the first user device, the multimedia content and at least one selection of modifiers to the multimedia content; and
customize the multimedia content based on the at least one selection, wherein the personalized purchase request further includes the customized multimedia content.

17. The system of claim 15, wherein the multimedia content element is a video showing the user of the first user device asking for the item.

18. The system of claim 1, wherein the sharing includes sending the widget, wherein the widget further includes code that, when executed at the second user device, configures the second user device to prompt a user of the second user device for payment information.

19. The system of claim 1, wherein the system is further configured to:
connect the second user device to a payment services provider system when a confirmation of the personalized purchase request is received from the second user device; and
cause a display of an interface for the payment services provider.
